(19) United States
(12) Patent Application Publication
(10) Pub. No.: US 2026/0358271 A1
(43) Pub. Date: Nov. 12, 2026

(54) INFORMATION PROCESSING SYSTEM, INFORMATION PROCESSING METHOD, AND PROGRAM

(71) Applicant: RIGAKU CORPORATION, Tokyo (JP)

(72) Inventors: Takumi OTA, Tokyo (JP); Hikari TAKAHARA, Osaka (JP)

(73) Assignee: RIGAKU CORPORATION, Tokyo (JP)

(21) Appl. No.: 19/491,428

(22) PCT Filed: Jan. 21, 2025
(86) PCT No.: PCT/JP2025/001651

§ 371 Date: Dec. 9, 2025

(30) Foreign Application Priority Data
Apr. 10, 2024 (JP) 2024-063109

(51) Int. Cl. G01N 23/085; G01N 23/2273

(52) U.S. Cl. CPC G01N 23/085; G01N 23/2273

(57) ABSTRACT

An information processing system including at least one processor is provided. The processor is configured to execute a program so as to execute an acquisition step of acquiring target measurement data that indicates a result of measurement using an X-ray for a sample to be analyzed and at least one piece of reference data; a designation reception step of receiving designation of the reference data; and a setting step of setting an objective function when performing non-negative matrix factorization based on the designation, the objective function including a linear combination of at least one variable basis and at least one fixed basis, the fixed basis each corresponding to the designated reference data, the variable basis having a component set to be a variable parameter during the non-negative matrix factorization, the fixed basis having a component set to be a fixed parameter during the non-negative matrix factorization.

### BACKGROUND

The present disclosure relates to an information processing system, an information processing method, and a program.

RELATED ART

Patent document 1 discloses a technology capable of returning a decomposition result that is close to the true basis spectrum in the decomposition of spectral data expected to have high primary independence.

The non-negative matrix factorization unit related to this technology obtains a plurality of basis spectral data and activation data by searching for a minimum value of an objective function that includes a deviation between a set of observed spectral data and a set of estimated spectral data calculated from the plurality of basis spectral data and the activation data, as well as a regularization term for evaluating the primary independence of the plurality of basis spectral data or the activation data.

### PRIOR ART DOCUMENTS

### Patent document

[Patent Document 1] JP 2019-087042 A

### SUMMARY

### Problems to be Solved by Invention

However, for example, when the peaks included in the spectrum overlap with each other, analyzing X-ray measurement results using non-negative matrix factorization based on the above technology may make it difficult to obtain stable analysis results.

### Means for Solving Problems

According to an aspect of the present disclosure, an information processing system is provided. This information processing system includes at least one processor. The processor is configured to execute a program so as to execute each of the following steps. The steps include an acquisition step of acquiring target measurement data that indicates a result of measurement using an X-ray for a sample to be analyzed and at least one piece of reference data;

The steps include a designation reception step of receiving designation of the reference data. The steps include a setting step of setting an objective function when performing non-negative matrix factorization based on the designation, the objective function including a linear combination of at least one variable basis and at least one fixed basis. Here, the fixed basis each corresponds to the designated reference data. The variable basis has a component that is set to be a variable parameter during the non-negative matrix factorization. The fixed basis has a component that is set to be a fixed parameter during the non-negative matrix factorization.

### BRIEF DESCRIPTION OF DRAWINGS

FIG. 1 is a configuration diagram representing an information processing system 1.

FIG. 2 is a diagram showing a configuration example of an X-ray measurement apparatus 2.

FIG. 3 is a block diagram showing a hardware configuration of an information processing apparatus 3.

FIG. 4 is an activity diagram showing an example of a flow of information processing executed in the information processing system 1.

FIG. 5 is a diagram showing a relationship between target measurement data, a variable basis, and a fixed basis included in an objective function.

FIG. 6 shows an example of an analysis screen IM1.

FIG. 7 is a diagram showing component analysis results of a SiO-based negative electrode material for a lithium secondary battery based on the present information processing.

FIG. 8 shows the component analysis results of a SiO-based negative electrode material for a lithium secondary battery based on linear combination fitting (LCF) as a comparative example.

### DETAILED DESCRIPTION

Hereinafter, an embodiment of the present disclosure will be described with reference to the drawings. Various features described in the embodiment below can be combined with each other.

A program for realizing a software described in an embodiment may be provided as a non-transitory computer-readable storage medium, may be provided to be downloaded from an external server, or may be provided so that the program is activated on an external computer to realize function thereof on a client terminal (so-called cloud computing).

In addition, in various information processing according to an embodiment, an input and an output in response to the input can be realized. Here, as long as an output is obtained as a result of an input, the aspect of information referenced in such information processing (hereinafter, referred to as reference information) is not limited. The reference information may be, for example, rule-based information such as a database, a lookup table, a predefined function (including a determination formula such as a regression formula constructed by statistical methods), may be a trained model in which the correlation between an input and an output has been learned in advance, or may be a large-scale language model that can output a desired result by inputting a prompt.

The term “unit” in an embodiment may include, for example, a combination of hardware resources implemented as circuits in a broad sense and information processing of software that can be concretely realized by these hardware resources. Furthermore, various information is handled in an embodiment, and the information can be represented by, for instance, physical values of signal values representing voltage and current, high and low signal values as a set of binary bits consisting of 0 or 1, or quantum superposition (so-called qubits), and communication/computation can be executed on a circuit in a broad sense.

Furthermore, the circuit in a broad sense is a circuit realized by combining at least an appropriate number of a circuit, circuitry, a processor, a memory, or the like. The processor may be a general-purpose processor or a dedicated circuit. In other words, a circuit includes an application specific integrated circuit (ASIC), a programmable logic device (e.g., simple programmable logic device (SPLD), a complex programmable logic device (CPLD), field programmable gate array (FPGA)), and the like.

### 1. Hardware Configuration

This Section Describes a Hardware Configuration.

### Information Processing System 1

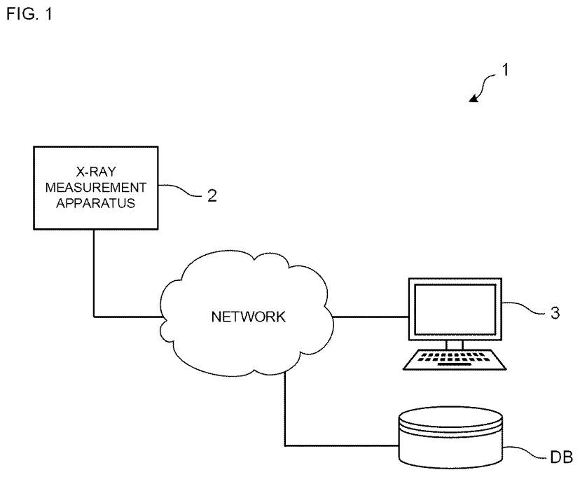

FIG. 1 is a configuration diagram representing an information processing system 1. The information processing system 1 according to the present embodiment is used to analyze the state of a sample as an analysis target using X-rays, for example, its structure, composition, valence, or chemical bonding state. The information processing system 1 includes, for example, a database DB, an X-ray measurement apparatus 2, and an information processing apparatus 3. The database DB, the X-ray measurement apparatus 2, and the information processing apparatus 3 are configured to be communicable via a telecommunication line. In one embodiment, the information processing system 1 includes one or more apparatuses or components. If, for example, the information processing system 1 only includes the information processing apparatus 3, the information processing system 1 can be the information processing apparatus 3. Hereinafter, explanation of these components will be provided.

### Database DB

The database DB stores reference data related to measurement using X-rays. The reference data may include open data or may be data that is provided in a limited manner only to certain users. The reference data is data that may be obtained when measurement using X-rays is performed on a material in a certain state. The reference data may include, for example, the results of measurement using X-rays performed on a predetermined reference sample, or predicted data of the results of measurement using X-rays obtained by simulation related to the reference sample. The reference sample is, for example, a sample having a known structure, composition, valence, chemical bonding state, or the like. The reference sample is preferably a single sample having a purity equal to or higher than a predetermined value (e.g., 99.99% or higher). Furthermore, examples of simulations related to the reference sample include any type of simulation, such as first-principles calculation assuming a certain defined system, band calculation, simulation based on the molecular orbital method, and molecular dynamics simulation.

### X-Ray Measurement Apparatus 2

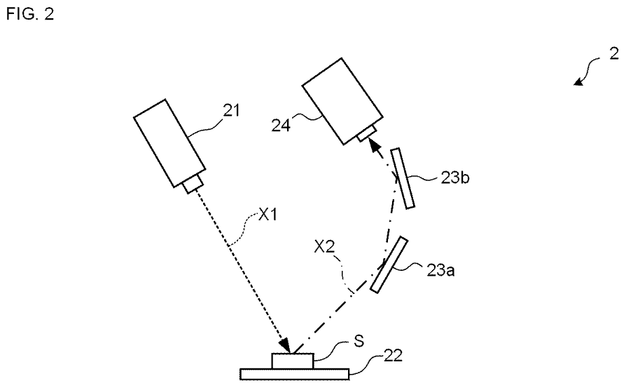

FIG. 2 is a diagram showing a configuration example of the X-ray measurement apparatus 2. The X-ray measurement apparatus 2 is configured to spectrally separate and detect fluorescent X-rays generated by irradiating a sample S with X-rays, and to generate the detection result as target measurement data. In the present embodiment, as one example, the X-ray measurement apparatus 2 is configured to measure X-rays in a manner that allows analysis of information on the microscopic chemical state, such as the valence and spin of elements constituting the sample S, based on X-ray emission spectroscopy (XES). Specifically, for example, the X-ray measurement apparatus 2 includes an X-ray irradiation part 21, a sample stage 22, two analyzing crystals 23a and 23b, and an X-ray detection part 24.

The X-ray irradiation part 21 is configured to irradiate X-rays X1. The X-ray irradiation part 21 can irradiate a target such as Cu, Mo, W, or Rh with thermoelectron from an electron gun, causing the target to irradiate characteristic X-rays. Hereinafter, for convenience of explanation, the X-ray X1 irradiated from the X-ray irradiation part 21 is referred to as an incident X-ray X1.

The sample stage 22 is configured so that a sample S to be analyzed can be placed thereon. The sample S placed on the sample stage 22 is arranged so as to be irradiated with the incident X-ray X1. The sample S that has been irradiated with the incident X-ray X1 outputs a fluorescent X-ray X2 corresponding to the constituent elements of the sample S.

The two analyzing crystals 23a and 23b are arranged to form a double-crystal monochromator. For example, the first analyzing crystal 23a is configured to reflect the fluorescent X-ray X2 generated from the sample S. The second analyzing crystal 23b is configured to further reflect the fluorescent X-ray X2 reflected by the first analyzing crystal 23a. Each of the analyzing crystals 23a and 23b is configured to adjust the reflection angle of the fluorescent X-ray X2 by rotating. The two analyzing crystals 23a and 23b are, for example, crystals made of the same material, and can selectively reflect a specific wavelength in accordance with the incident angle of the fluorescent X-ray X2 by Bragg reflection. This makes it possible to spectrally separate monochromatic light of a desired energy band from the fluorescent X-ray X2 generated from the sample S by appropriately adjusting the reflection angles of the fluorescent X-ray X2 by the first analyzing crystal 23a and the second analyzing crystal 23b. Note that the specific aspect of the optical system for spectrally separating the fluorescent X-ray X2 is not limited to the above and may be any configuration.

The X-ray detection part 24 is configured to detect X-rays that have passed via the sample S, and thereby to output the results of measurement of the X-rays. The specific aspect of the X-ray detection part 24 is arbitrary, but a proportional counter, a scintillation counter, a semiconductor detector, and the like may be used. In the present embodiment, the X-ray detection part 24 is configured to detect components that have been spectrally separated by the analyzing crystals 23a and 23b, in the fluorescent X-ray X2 generated from the sample S due to the incident X-ray X1.

### Information Processing Apparatus 3

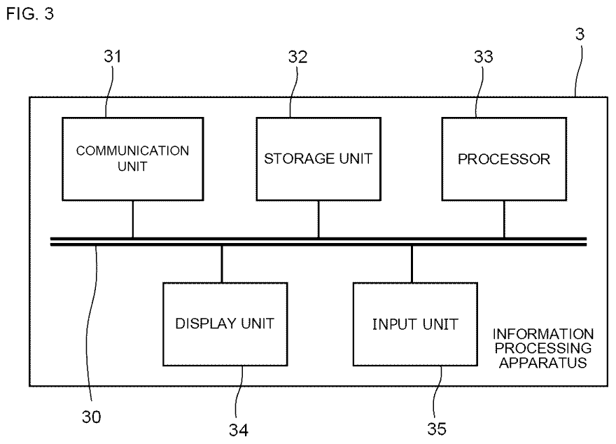

FIG. 3 is a block diagram showing a hardware configuration of the information processing apparatus 3. The information processing apparatus 3 includes a communication bus 30, a communication unit 31, a storage unit 32, a processor 33, a display unit 34, and an input unit 35, and these components are electrically connected via the communication bus 30 inside the information processing apparatus 3.

It is preferable for the communication unit 31 to include wired communication means such as USB, IEEE 1394, Thunderbolt (registered trademark), and wired LAN network communication. The communication unit 31 may also include wireless LAN network communication, mobile communication such as 3G/LTE/5G, and BLUETOOTH (registered trademark) communication as necessary. That is, it is more preferable to implement the communication unit 31 as a set of these multiple types of communication means. That is, the information processing apparatus 3 may communicate various types of information from the outside via the communication unit 31 and the network.

The storage unit 32 stores various types of information defined by the foregoing description. For example, this may be implemented as a storage device such as a solid-state drive (SSD) that stores various programs pertaining to the information processing apparatus 3 that are executed by the processor 33, or as a memory such as random-access memory (RAM) that stores temporarily required information (such as arguments and arrays) pertaining to the program operations. The storage unit 32 stores various programs and variables, etc. pertaining to the information processing apparatus 3 and executed by the processor 33.

The processor 33 processes and controls overall operation related to the information processing apparatus 3. The processor 33 is, for example, an unshown central processing unit (CPU). The processor 33 reads out a predetermined program stored in the storage unit 32 so as to realize various functions pertaining to the information processing apparatus 3. That is, the information processing by software stored in the storage unit 32 is specifically realized by the processor 33 as an example of hardware, and can be executed as each functional unit included in the processor 33. They will be described in more detail in the next section. Note that the processor 33 is not limited to be a single unit, and may be implemented with multiple processors 33 for the individual functions. A combination of the above is also acceptable.

The processor 33 is configured to acquire information from the X-ray measurement apparatus 2 or other devices as an acquisition unit. The processor 33 is configured to acquire various types of information by: reading out the various types of information stored in a storage area, which is at least a part of the storage unit 32; and writing the readout information into a working area, which is at least a part of the storage unit 32. The storage area is, for example, an area in the storage unit 32, which is implemented as a storage device such as an SSD. The working area is, for example, an area which is implemented as a memory such as RAM. Note that the acquisition by the processor 33 includes acquiring output results of each functional unit included in the processor 33.

The processor 33 is configured to display various types of information as a display processing unit. This information can be presented to a user via the display unit 34 described later or other devices. In such a case, for example, the processor 33 controls the display unit 34 of the information processing apparatus 3 to display visual information such as screens, images including still or moving images, icons, messages and the like. The processor 33 may generate only rendering information for displaying the visual information on the information processing apparatus 3. Note that the processor 33 may present the output information to the user not via the information processing apparatus 3 or any other device users.

The display unit 34 may be included in a housing of the information processing apparatus 3, or may be externally provided. The display unit 34 displays a screen of a graphical user interface (GUI) that can be operated by a user. For example, this is preferable to be implemented by using different display devices such as a CRT display, a liquid crystal display, an organic EL display, and a plasma display, depending on the type of the information processing apparatus 3.

The input unit 35 is configured to receive inputs from the user. The input unit 35 may be included in the housing of the information processing apparatus 3, or may be externally provided. For example, the input unit 35 may be implemented as a touchscreen integrated with the display unit 34. If it is a touchscreen, the user can input operations such as tapping, swiping, and the like. Of course, instead of a touchscreen, devices such as switch buttons, a mouse, a QWERTY keyboard, a voice recognition device, a gesture measuring device, a line-of-sight measuring device, a biological signal measuring device, and an imaging apparatus may be adopted. That is, the input unit 35 accepts operation inputs performed by the user. The input unit 35 transfers a signal corresponding to the operation input to the processor 33 via the communication bus 30 as a response. The processor 33 can execute predetermined control or computation as necessary.

### 2. Information Processing

This section describes the information processing executed in the information processing system 1 described above.

### 2.1. Flow of Information Processing

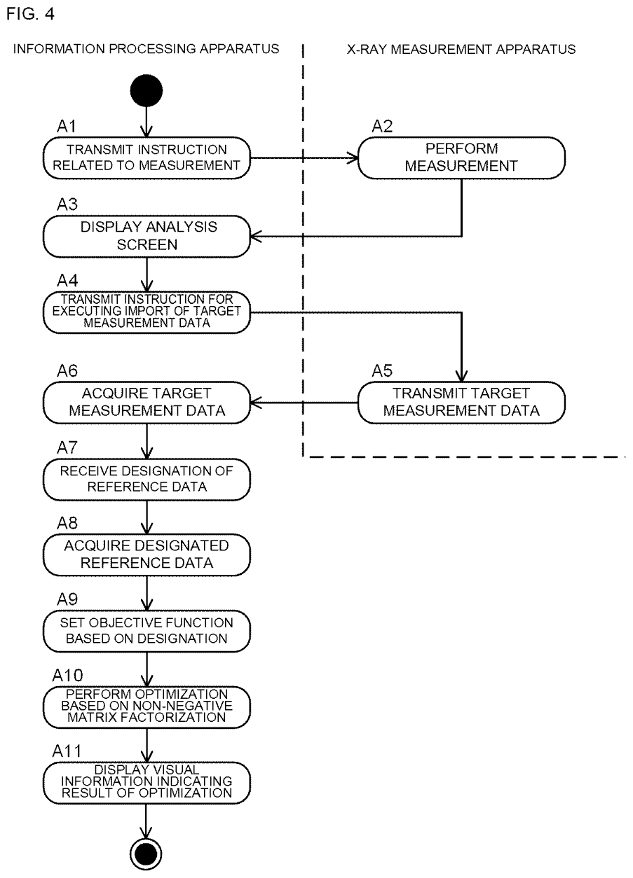

FIG. 4 is an activity diagram showing an example of a flow of information processing executed in the information processing system 1. Note that the information processing may include arbitrary exception processing which is not shown in the drawings. The exception processing includes interruption of the information processing and omission of each process. Selection or input performed in the information processing may be based on operations by the user, or may be automatic not by the user's operations.

### Activity A1

First, in Activity A1, the processor 33 transmits an instruction related to measurement to the X-ray measurement apparatus 2. The instruction related to measurement may include any information related to the incident X-ray X1 irradiated to the sample S, such as the irradiation intensity, irradiation time, and irradiation position of the incident X-ray X1. Furthermore, the instruction related to measurement may also include information related to the rotation speed of the analyzing crystals 23a and 23b (in other words, the integration time and step width of the fluorescent X-ray X2 in a certain energy band). In other words, the instruction related to measurement may include a measurement sequence. Furthermore, the instruction related to measurement may include an instruction related to the start of measurement.

### Activity A2

Next, in Activity A2, the X-ray measurement apparatus 2 performs measurement on the sample S based on the instruction related to measurement transmitted from the processor 33. Accordingly, the X-ray measurement apparatus 2 generates the results detected by the X-ray detection part 24 as target measurement data. The target measurement data indicates the results of measurement using X-rays for the sample S to be analyzed. The result of measurement using X-rays indicates, for example, a result of spectrum measurement using X-rays. In the present embodiment, the X-ray measurement apparatus 2 is configured to perform measurement using XES, and the target measurement data is spectral data obtained as a measurement result using XES, including the energy (in other words, wavelength) of X-rays detected by the X-ray detection part 24 corresponding to the angle between the analyzing crystals 23a and 23b, and the number of X-ray photons (count) detected by the X-ray detection part 24 for each energy.

### Activity A3

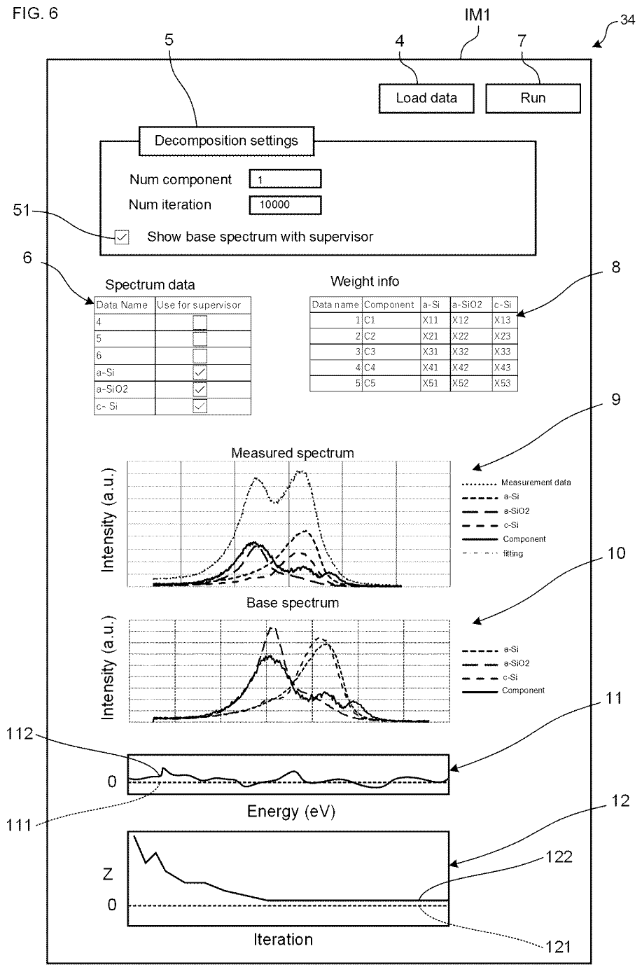

Then, in Activity A3, the processor 33 causes the display unit 34 to display an analysis screen IM1 (see FIG. 6). The analysis screen IM1 is configured to receive various operations from the user.

### Activity A4

Next, in Activity A4, the processor 33 transmits an instruction for executing the import of the target measurement data to the X-ray measurement apparatus 2.

### Activity A5

Next, in Activity A5, the X-ray measurement apparatus 2 transmits the target measurement data generated by the X-ray detection part 24 to the information processing apparatus 3 based on the transmitted data acquisition instruction.

### Activity A6

Next, in Activity A6, the processor 33 acquires the target measurement data transmitted from the X-ray measurement apparatus 2. Note that the information source of the target measurement data for the processor 33 is not limited to the information processing apparatus 3, and other devices such as the storage unit 32 storing the target measurement data may also be used as the information source.

### Activity A7

Next, in Activity A7, the processor 33 receives designation of reference data. For example, the processor 33 receives an input by the user to the UI displayed on the analysis screen IM1 as the designation of reference data.

### Activity A8

Next, in Activity A8, the processor 33 acquires at least one piece of reference data. The processor 33, for example, may acquire the designated reference data by reading it from the database DB, or may acquire information stored in advance in the storage unit 32 or the like as the reference data. The reference data is configured to be comparable to the target measurement data. For example, the reference data is configured to indicate the relationship between the energy of X-rays and the number of photons of X-rays at that energy.

### Activity A9

Next, in Activity A9, the processor 33 sets an objective function when performing non-negative matrix factorization based on the designation of the reference data. The objective function is an index to be maximized (or minimized) during optimization. The objective function includes a linear combination of at least one variable basis and at least one fixed basis. The fixed basis each corresponds to the designated reference data. The components of the fixed basis are set to be fixed parameters during the non-negative matrix factorization. The components of the variable basis are set to be variable parameters during the non-negative matrix factorization.

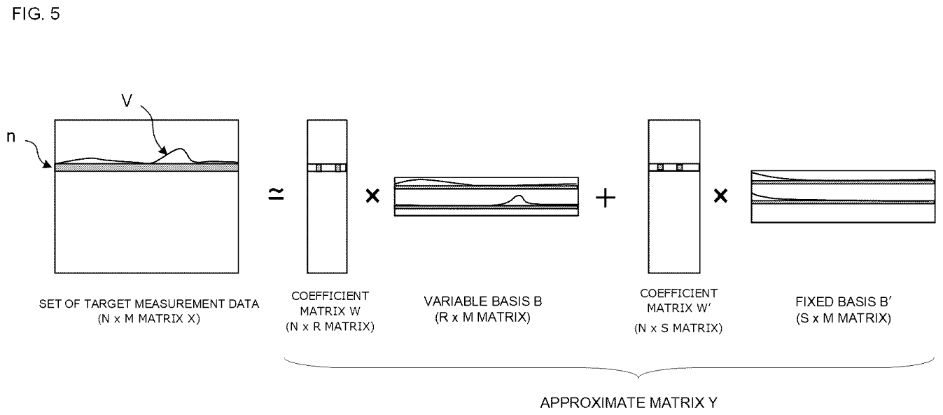

Here, an example of how the objective function is set will be described. FIG. 5 is a diagram showing a relationship between the target measurement data, the variable basis, and the fixed basis included in the objective function. Here, the target measurement data is spectral data showing the results of measuring the number of photons of fluorescent X-rays X2 in M energy bands. The processor 33 processes a set of target measurement data for each measurement performed under N different measurement conditions as an N×M matrix. Here, the set of target measurement data is represented as a matrix X. The “n” in FIG. 5 represents the nth target measurement data, and the V in the matrix X represents the number of photons for each energy of the nth target measurement data. Note that if there is only one piece of target measurement data, the processor 33 may treat the 1×m matrix as a matrix X representing the set of target measurement data.

Next, the processor 33 sets a fixed basis based on the reference data acquired from the database DB or the like based on the designation. First, the processor 33 acquires the number of photons of fluorescent X-rays X2 in the M energy bands included in the target measurement data so that the reference data can be compared with the target measurement data. The processor 33 acquires, for example, data points included in the spectrum included in the reference data, or estimated values calculated from the data points using spline interpolation, trapezoidal approximation, or the like. Note that the number of photons at this time is a relative value within the entire spectrum, and may be normalized, for example, so that the maximum value is a predetermined value. For example, when the reference data for S different reference samples are designated, the processor 33 treats the set of R pieces of reference data as an S×M matrix. In this manner, the processor 33 treats each of the spectra obtained based on the reference data as a fixed basis. For example, when S pieces of reference data are designated, the processor 33 sets a total of S fixed bases from each of the reference data and treats these fixed bases as an S×M matrix B′. The matrix B′ constitutes a set of fixed bases, and the sequence of numbers in each row of the matrix B′ represents the spectrum of each reference data for each of the designated reference samples.

Next, an approximate matrix Y for the target measurement data is generated. The approximate matrix Y includes a linear combination of a variable basis and a fixed basis. For example, the approximate matrix Y may include the following terms.

Y=W×B+W′×B′ [Equation 1]

Here, B represents a set of bases treated as variable parameters during optimization of the objective function described later, and can be expressed as an R×M matrix. However, R is an integer greater than or equal to 1, and may correspond to the number of unspecified components contained in the sample S. Each element of the R×M matrix corresponding to matrix B is treated as a variable parameter during optimization described later. W and W′ are coefficient matrices of the matrix B corresponding to the variable basis and the matrix B′ corresponding to the fixed basis, respectively. Each element thereof is treated as a variable parameter during optimization described later. For example, the coefficient matrix W of the matrix B corresponding to the variable basis is formulated using an N×R matrix, and the coefficient matrix W′ of the matrix B′ corresponding to the fixed basis is formulated using an N×S matrix. Note that the approximate matrix Y may include other elements such as a constant matrix.

Next, the processor 33 sets the objective function Z based on the set approximate matrix Y. The objective function Z is configured to approximate the above-mentioned approximate matrix Y as the matrix X representing the target measurement data, by being optimized. For example, the objective function Z may be defined as a norm shown below.

Z=∥X−Y∥=∥X−W×B−W′×B′∥ [Equation 2]

Note that the specific aspect of the norm is arbitrary, and examples include the L1 norm (Manhattan distance) and the L2 norm (Euclidean distance). In this manner, the objective function Z further includes a linear combination of a variable basis and a fixed basis, and can be set so that at least the variable basis and the coefficient of the variable basis are variable parameters. As a result, as the approximate matrix Y approaches the matrix X corresponding to the target measurement data through optimization, the objective function Z becomes smaller and, ideally, becomes 0. In this time, among the parameters included in the objective function Z, the elements included in the coefficient matrices W and W′ and the matrix B corresponding to the variable basis are treated as variable parameters during optimization, while the elements included in the matrix B′ corresponding to the fixed basis are treated as fixed values. Note that each element of the matrices X, B, B′, W, and W′ is defined to be non-negative. Thus, the objective function Z is set to perform non-negative matrix factorization, which decomposes the matrix X into B and B′ as non-negative matrix factors.

### Activity A10

Returning to FIG. 4, after Activity A9, in Activity A10, the processor 33 performs optimization based on non-negative matrix factorization using the set objective function Z. Here, the processor 33 adjusts variable parameters so that the value of the objective function Z becomes smaller, and determines that the optimization is complete when the objective function Z satisfies the predetermined optimization conditions. The processor 33 outputs, as the optimal solution, the parameter among those during optimization whose value of the objective function Z is closest to zero. Specifically, by setting variable parameters and fixed values as described above, the processor 33 performs non-negative matrix factorization of the matrix X corresponding to the target measurement data by optimizing the objective function Z for the matrix X corresponding to the target measurement data under the constraint that at least the components of the fixed basis (corresponding to the elements of the matrix B′) of the objective function Z are fixed. The specific aspect of the algorithm for searching for the optimal solution by adjusting variable parameters is arbitrary, but examples include a local search method, a successive improvement method, and a neighborhood search method. Additionally, a metaheuristic search method such as cuckoo search, a genetic algorithm, and particle swarm optimization can be adopted as an optimization processing algorithm.

### Activity A11

Next, in Activity A11, the processor 33 causes the display unit 34 to display visual information indicating the results of the optimization performed in Activity A10. In the present embodiment, the processor 33 displays the visual information on the analysis screen IM1.

According to the above configuration, it is possible to reduce the search range of parameters during optimization by the components of the fixed basis, while making maximal use of the information of known reference samples. Thus, when analyzing the results of measurement using X-rays, the processing load required to perform non-negative matrix factorization on the target measurement data can be reduced. In particular, the non-negative matrix factorization can be applied even when there is a large overlap of multiple X-ray peaks that may be included in the target measurement data. Therefore, particularly for measurement data in which the X-ray peaks overlap, the processing load can be reduced while utilizing the characteristics of non-negative matrix factorization.

### 2.2. Example of Analysis Screen

This section describes an example of the analysis screen IM1 described above. FIG. 6 shows an example of the analysis screen IM1. Here, as an example, the target measurement data indicates the results of XES measurement for a heat-treated Si-based material. As shown in FIG. 6, the analysis screen IM1 includes, for example, a load button 4, a setting area 5, a designation reception area 6, an execution button 7, a quantitative information area 8, a result display area 9, a basis display area 10, a residual area 11, and a score display area 12.

The load button 4 is configured to transmit an instruction to execute import of the target measurement data in response to a user operation. When the load button 4 is operated, the processor 33 first receives the designation of the target measurement data to be imported, and then imports the designated target measurement data.

The setting area 5 is a UI configured to receive designation regarding the conditions when performing optimization using non-negative matrix factorization. The setting area 5 is configured to allow designation of, for example, the number of components contained in the sample S (“Num component”) and the number of optimization iterations (“Num iteration”). In the present embodiment, the setting area 5 may include a display setting area 51. The display setting area 51 is configured so that it is possible to designate whether or not to visually display the results of measurement using X-rays corresponding to the variable basis or the results of a simulation related to the measurement.

The designation reception area 6 is an example of visual information configured to allow candidates for reference data designatable based on the acquired reference data to be listed. The designation reception area 6 includes the name of the reference data (“Data Name”) and a checkbox (“Use for supervisor”) in which designation for the candidate for the reference data can be entered. The processor 33 treats the reference data whose checkbox is checked as the designated reference data. In this way, the processor 33 receives designation from the user by displaying the designation reception area 6. In the present embodiment, as an example, the processor 33 displays the spectral patterns of a-Si (amorphous Si), a-SiO2 (amorphous Si02), and c-Si (crystalline silicon) as reference samples as candidates for reference data, and receives the designation of the spectral patterns of these three substances.

The execution button 7 is a UI for executing the optimization of the objective function. When the user operates the execution button 7, the processor 33 sets the objective function Z according to the conditions set in the setting area 5 and the designation reception area 6, and starts optimization with the number of iterations entered in “Num iteration” as the upper limit.

The quantitative information area 8, the result display area 9, the basis display area 10, the residual area 11, and the score display area 12 are areas that show the optimization process or results when optimization is performed.

The quantitative information area 8 is an area that quantitatively displays the results of non-negative matrix factorization of the matrix X, which is defined by a set of target measurement data. Each row displayed in the quantitative information area 8 corresponds to each row of the target measurement data stored in the matrix X. “Data Name” in the quantitative information area 8 indicates the file name of each target measurement data. “Component” in the quantitative information area 8 indicates an element of the coefficient matrix W of the variable basis, i.e., the quantity of an unknown component contained in the sample S other than the component represented by the fixed basis, such as a composition ratio.

The result display area 9 is an example of result visual information indicating the results of non-negative matrix factorization of the matrix X corresponding to the target measurement data. The result display area 9 is configured to display a first contribution related to the variable basis and a second contribution related to the fixed basis among the target measurement data obtained as a result of the non-negative matrix factorization, in a manner distinguishable from each other. For example, the result display area 9 may include the spectrum of the optimized variable basis (“Component”) as the first contribution and the respective spectra of the weighted fixed bases (“a-Si,” “a-SiO2,” and “c-Si”) as the second contribution. These contributions are displayed as graphs in the result display area 9 in a visually distinguishable manner, for example, by line type, color, thickness, etc. In addition, the processor 33 may cause the display unit 34 to display the first contribution and the second contribution in a visually distinguishable manner in the result display area 9 by erasing one of the first contribution and the second contribution (for example, only the second contribution).

The result display area 9 may also be configured to visually display the spectrum of the target measurement data to be analyzed (“Measurement data”) and the optimized spectrum (“fitting”) corresponding to the approximate matrix Y. With this configuration, the contribution of each component can be viewed together while comparing the spectrum of the target measurement data with the optimized spectrum.

The basis display area 10 is configured to display the spectra of the variable basis and the fixed basis as superimposed graphs. This configuration makes it easier to understand the relationship between the spectrum to be basis and the spectrum of the target measurement data.

The horizontal axis of the result display area 9 and the basis display area 10 indicates, for example, the values of parameters (e.g., the energy of fluorescent X-rays X2, the scattering angle, or the like) in the measurement conditions for measurement using X-rays. The vertical axis of the result display area 9 and the basis display area 10 indicates the detection result by the X-ray detection part 24, for example, the number of photons or the like. Here, the vertical axis indicates the intensity of X-rays (“Intensity”), which is a quantity corresponding to the number of photons. Note that the intensity of X-rays here is relative.

The basis display area 10 is preferably configured so as to be viewed together with the result display area 9. In particular, the horizontal axis of the basis display area 10 is preferably displayed so as to correspond to the horizontal axis of the result display area 9. This configuration makes it easier to compare the target measurement data with each basis. In this case, it is preferable that the scale of the vertical axis in the basis display area 10 is independently settable so as to be different from the scale of the result display area 9. With this configuration, it is possible to grasp the spectrum of minute components that may be included in the target measurement data by enlarging the basis display area 10.

The residual area 11 is an area configured to visually display the difference between the spectrum of the target measurement data and the spectrum of the optimized approximate matrix Y. This difference is an example of information related to the transition of an index indicating the accuracy of optimization, such as the difference between the spectrum of the target measurement data and the spectrum of the optimized approximate matrix Y, i.e., the residual. The residual area 11 is configured to visually represent this residual as a spectrum. The residual area 11 includes, for example, a reference line 111 and a residual spectrum 112. The reference line 111 indicates a graph (e.g., a straight line graph) where the residual is zero. The residual spectrum 112 is a graph configured to indicate the difference for each energy band. The user can analyze which energy band has low optimization accuracy by comparing the positions of the residual spectrum 112 relative to the reference line 111 for each energy band. The residual area 11 can be displayed so as to be viewed together with the result display area 9 and/or the basis display area 10. In this case, the horizontal axis of the residual area 11 is displayed so as to correspond to the horizontal axis of the result display area 9 and/or the basis display area 10.

The score display area 12 is configured to indicate changes in the objective function Z as an example of information related to the transition of an index indicating the accuracy of optimization during the optimization process. The score display area 12 can be updated so that the latest value of the objective function Z is visually displayed as the optimization progresses. This configuration makes it easier to understand whether the optimization is progressing smoothly, and can prompt the user to interrupt the optimization in the case where, for example, a variable parameter of the objective function Z is trapped in a local optimal solution. The horizontal axis of the score display area 12 indicates the number of iterations (“Iteration”), and the vertical axis of the score display area 12 indicates the value of the objective function Z at the corresponding number of iterations. The score display area 12 may include a theoretical value 121 and a transition graph 122. The theoretical value 121 indicates the value when the objective function Z is 0, that is, when the approximate matrix Y exactly matches the matrix X corresponding to the target measurement data. The transition graph 122 shows the transition of the objective function Z as the number of iterations changes. When optimization is proceeding smoothly, the value of the objective function Z gradually converges to the theoretical value 121 as the number of iterations increases. On the other hand, when the optimization is not proceeding smoothly because it is trapped in a local optimal solution or the value of the objective function Z is oscillating, the transition graph 122 will have a shape different from that when the optimization is proceeding smoothly. Such difference in the shape of the transition graph 122 can prompt the user whether or not to interrupt the optimization.

In this way, the processor 33 visually displays information related to the transition of the index indicating the accuracy of optimization through the residual area 11 and the score display area 12. This configuration makes it possible to visually grasp problems such that the optimization is trapped in a local optimal solution and has been completed with insufficient accuracy.

### 2.3. Example of Optimization

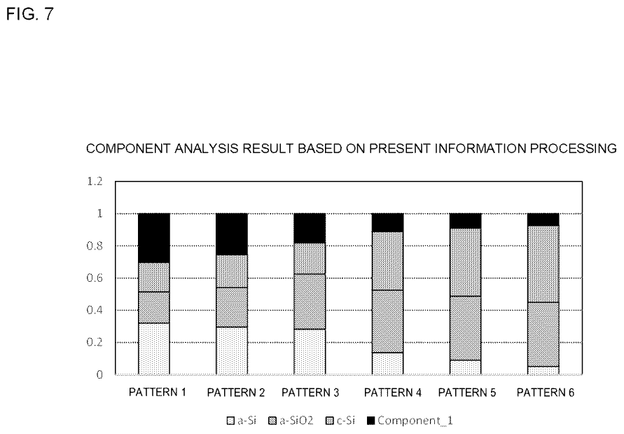

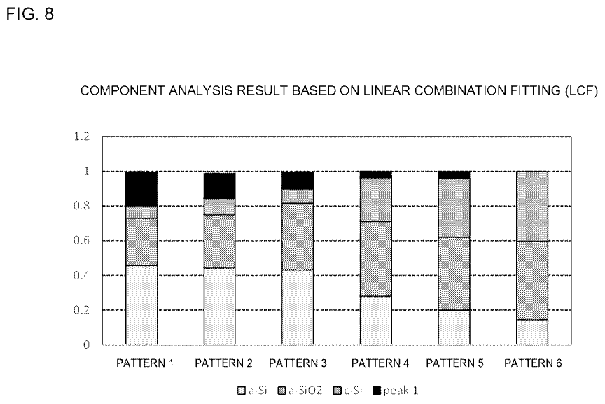

Next, an example of the component analysis results of a Si-based material using the above-mentioned information processing method will be described. FIG. 7 is a diagram showing the component analysis results of a SiO-based negative electrode material for a lithium secondary battery based on the present information processing. FIG. 8 shows the component analysis results of a SiO-based negative electrode material for a lithium secondary battery based on linear combination fitting (LCF) as a comparative example. Optimization to obtain each component analysis result was performed under the assumption that the sample contains at least amorphous Si, amorphous SiO2, and crystalline Si, and that the number of unknown components was one. The sample S subjected to X-ray measurement was obtained by performing a predetermined heat treatment on a SiO-based negative electrode material for a lithium secondary battery.

The sample S corresponding to pattern 1 shown in FIG. 7 and FIG. 8 was obtained without heating the SiO negative electrode material for a lithium secondary battery. The samples S corresponding to patterns 2 to 6 were obtained by heating the SiO negative electrode material for a lithium secondary battery in an air atmosphere at heating temperatures of 700 °C, 800 °C, 900 °C, 1000 °C, and 1100 °C, respectively.

As shown in FIG. 7 and FIG. 8, both the component analysis results based on the present information processing and the component analysis results based on the LCF contained components of amorphous Si, amorphous SiO2, and crystalline Si, as well as unknown components. Here, in the component analysis based on the present information processing, the number of types of unknown components was assumed, and optimization is performed with the spectra corresponding to the unknown components (corresponding to each row of the matrix B) and their contributions (corresponding to the elements of the coefficient matrix) as variable parameters, thereby determining the spectra of the unknown components and their contributions. Here, the number of types of unknown components was set to 1. In FIG. 7, the unknown component in the present information processing is represented as “Component_1.”

Furthermore, in the component analysis based on the LCF, the spectrum corresponding to the unknown component is determined in advance using a predetermined analysis method, and then optimization is performed with that spectrum fixed to determine the contribution of the unknown component. In FIG. 8, the unknown component in the optimization by the LCF is represented as “peak 1”.

Both component analysis results showed that while the component of the amorphous Si and the unknown component both tended to decrease as the heating temperature increased, the component of the amorphous SiO2 and the component of the crystalline Si tended to increase as the heating temperature increased. Accordingly, the component analysis results based on the present information processing shows similar trends to those based on the LCF, which is often used especially when there is a large overlap of the peaks. This indicates that the present information processing method provides analysis results with high accuracy comparable that of LCF even when the spectra derived from each component have significant overlap, although the present information processing method is an optimization algorithm based on the non-negative matrix factorization.

### Others

The above embodiment may be modified as follows.

In the above embodiment, the execution subject of optimization performed in Activity A10 is not limited to the processor 33, and may be any device other than the information processing apparatus 3.

In the above embodiment, the fluorescent X-ray X2 detected by the X-ray detection part 24 was obtained by irradiating the sample S with the incident X-ray X1 from the X-ray irradiation part 21. However, the present disclosure is not limited thereto. For example, the fluorescent X-ray X2 may be obtained by irradiating the sample S with an electron beam having a certain energy or higher. Specifically, for example, the X-ray measurement apparatus 2 may be a SEM-EDS system. In addition, the specific aspect of measurement using X-rays performed by the X-ray measurement apparatus 2 is arbitrary, and examples include measurement by X-ray fluorescence analysis (XRF), X-ray emission spectroscopy (XES), X-ray photoelectron spectroscopy (XPS), or X-ray absorption spectroscopy (XAFS). The specific aspect of the optical system of the X-ray measurement apparatus 2 may be changed as appropriate depending on the type of measurement using X-rays.

In the present embodiment, the information processing apparatus 3 functions as both a measurement terminal that transmits an instruction related to measurement by the X-ray measurement apparatus 2 and an analysis terminal for analyzing the target measurement data. However, the analysis terminal may be separate from the measurement terminal.

The information processing apparatus 3 may be in an on-premises system or a cloud system. The information processing apparatus 3 in the cloud system may provide the above-described functions and processing in a form of, for example, cloud computing such as Saas (Software as a Service).

In the above embodiment, the information processing apparatus 3 executes various storage and control operations, but multiple external devices may be used instead of the information processing apparatus 3. In other words, various information and programs may be divided to be stored into multiple external devices by using blockchain technology or the like.

The above embodiment is not limited to the information processing system 1, and may be an information processing method or an information processing program. The information processing method includes each step of the information processing system 1. The program is configured to cause at least one computer to execute each step of the information processing system 1.

The above-described information processing system 1 and the like may be provided in each of the following aspects. configured to execute a program so as to execute each of steps including: an acquisition step of acquiring target measurement data that indicates a result of measurement using an X-ray for a sample to be analyzed and at least one piece of reference data; a designation reception step of receiving designation of the reference data; and a setting step of setting an objective function when performing non-negative matrix factorization based on the designation, the objective function including a linear combination of at least one variable basis and at least one fixed basis, the fixed basis each corresponding to the designated reference data, the variable basis having a component that is set to be a variable parameter during the non-negative matrix factorization, the fixed basis having a component that is set to be a fixed parameter during the non-negative matrix factorization.

According to such a configuration, the search range for parameters during optimization can be reduced by the components of the fixed basis, while making maximal use of the information of known reference samples. Thus, when analyzing the results of measurement using X-rays, the processing load required to perform non-negative matrix factorization on the target measurement data can be reduced. Here, in particular, the non-negative matrix factorization can be applied even when there is a large overlap of multiple X-ray peaks that may be included in the target measurement data. Therefore, particularly for measurement data in which the X-ray peaks overlap, the processing load can be reduced while utilizing the characteristics of non-negative matrix factorization.

(2) The information processing system according to (1), wherein: the reference data includes a result of measurement using the X-ray performed on a predetermined reference sample, or a prediction of a result of measurement using the X-ray obtained by simulation related to the reference sample.

(3) The information processing system according to (1) or (2), wherein: the objective function further includes a linear combination of the variable basis and the fixed basis, and is set so that at least the variable basis and a coefficient of the variable basis are variable parameters.

(4) The information processing system according to any one of (1) to (3), wherein: the designation reception step includes receiving the designation from a user by displaying visual information configured to allow candidates for reference data designatable based on the acquired reference data to be listed.

(5) The information processing system according to any one of (1) to (4), wherein: the processor is further configured to execute a program so as to execute an optimization step of optimizing the objective function for a matrix corresponding to the target measurement data under a constraint that at least the component of the fixed basis of the objective function is fixed, thereby performing non-negative matrix factorization of the matrix corresponding to the target measurement data.

(6) The information processing system according to (5), wherein: the processor is further configured to execute a program so as to execute an analysis display step of visually displaying information related to transition of an index indicating accuracy of the optimization.

(7) The information processing system according to any one of (1) to (6), wherein: a result of measurement using the X-ray indicates a result of spectrum measurement using an X-ray.

(8) The information processing system according to any one of (1) to (7), wherein: the result of measurement using the X-ray indicates a result of measurement by X-ray fluorescence analysis (XRF), X-ray emission spectroscopy (XES), X-ray photoelectron spectroscopy (XPS), or X-ray absorption spectroscopy (XAFS).

(9) The information processing system according to any one of (1) to (8), wherein: the processor is further configured to execute a program so as to execute a result display step of displaying result visual information indicating a result of the non-negative matrix factorization, and the result visual information allows a first contribution related to the variable basis and a second contribution related to the fixed basis among the target measurement data obtained as a result of the non-negative matrix factorization to be displayed in a manner distinguishable from each other.

(10) The information processing system according to any one of (1) to (9), further comprising an X-ray measurement apparatus, wherein the X-ray measurement apparatus includes: an X-ray irradiation part configured to irradiate the X-ray; a sample stage configured so that a sample to be analyzed is placeable thereon; and an X-ray detection part configured to detect an X-ray that has passed via the sample and thereby output a result of measurement of the X-ray.

(11) An information processing method comprising each step of the information processing system according to any one of (1) to (10).

(12) A program configured to cause at least one computer to execute each step of the system according to any one of (1) to (10).

Of course, the present disclosure is not limited to the above aspects.

Finally, various embodiments of the present disclosure have been described, but these are presented as examples and are not intended to limit the scope of the disclosure. The novel embodiment can be implemented in various other forms, and various omissions, replacements, and changes can be made without departing from the abstract of the disclosure. The embodiment and its modifications are included in the scope and abstract of the disclosure and are included in the scope of the disclosure described in the claims and the equivalent scope thereof.

### REFERENCE SIGNS LIST

1: Information processing system
2: X-ray measurement apparatus
21: X-ray irradiation part
22: Sample stage
23a: First analyzing crystal
23b: Second analyzing crystal
24: X-ray detection part
3: Information processing apparatus
30: Communication bus
31: Communication unit
32: Storage unit
33: Processor
34: Display unit
35: Input unit
4: Load button
5: Setting area
51: Display setting area
6: Designation reception area
7: Execution button
8: Quantitative information area
9: Result display area
10: Basis display area
11: Residual area
111: Reference line
112: Residual spectrum
12: Score display area
121: Theoretical value
122: Transition graph
DB: Database
IM1: Analysis screen
S: Sample
X1: Incident X-ray
X2: Fluorescent X-ray

What is claimed is:

1. An information processing system, comprising at least one processor configured to execute a program so as to execute each of steps including:
an acquisition step of acquiring target measurement data that indicates a result of measurement using an X-ray for a sample to be analyzed and at least one piece of reference data;
a designation reception step of receiving designation of the reference data; and
a setting step of setting an objective function when performing non-negative matrix factorization based on the designation, the objective function including a linear combination of at least one variable basis and at least one fixed basis,
the fixed basis each corresponding to the designated reference data,
the variable basis having a component that is set to be a variable parameter during the non-negative matrix factorization,
the fixed basis having a component that is set to be a fixed parameter during the non-negative matrix factorization.

2. The information processing system according to claim 1, wherein:
the reference data includes a result of measurement using the X-ray performed on a predetermined reference sample, or a prediction of a result of measurement using the X-ray obtained by simulation related to the reference sample.

3. The information processing system according to claim 1, wherein:
the objective function further includes a linear combination of the variable basis and the fixed basis, and is set so that at least the variable basis and a coefficient of the variable basis are variable parameters.

4. The information processing system according to claim 1, wherein:
the designation reception step includes receiving the designation from a user by displaying visual information configured to allow candidates for reference data designatable based on the acquired reference data to be listed.

5. The information processing system according to claim 1, wherein:
the processor is further configured to execute a program so as to execute an optimization step of optimizing the objective function for a matrix corresponding to the target measurement data under a constraint that at least the component of the fixed basis of the objective function is fixed, thereby performing non-negative matrix factorization of the matrix corresponding to the target measurement data.

6. The information processing system according to claim 5, wherein:
the processor is further configured to execute a program so as to execute
an analysis display step of visually displaying information related to transition of an index indicating accuracy of the optimization.

7. The information processing system according to claim 1, wherein:
a result of measurement using the X-ray indicates a result of spectrum measurement using an X-ray.

8. The information processing system according to claim 1, wherein:
the result of measurement using the X-ray indicates a result of measurement by X-ray fluorescence analysis (XRF), X-ray emission spectroscopy (XES), X-ray photoelectron spectroscopy (XPS), or X-ray absorption spectroscopy (XAFS).

9. The information processing system according to claim 1, wherein:
the processor is further configured to execute a program so as to execute
a result display step of displaying result visual information indicating a result of the non-negative matrix factorization, and
the result visual information allows a first contribution related to the variable basis and a second contribution related to the fixed basis among the target measurement data obtained as a result of the non-negative matrix factorization to be displayed in a manner distinguishable from each other.

10. The information processing system according to claim 1, further comprising an X-ray measurement apparatus, wherein
the X-ray measurement apparatus includes:
an X-ray irradiation part configured to irradiate the X-ray;
a sample stage configured so that a sample to be analyzed is placeable thereon; and
an X-ray detection part configured to detect an X-ray that has passed via the sample and thereby output a result of measurement of the X-ray.

11. An information processing method comprising each step of the information processing system according to claim 1.

12. A non-transitory computer-readable storage medium storing a program configured to cause at least one computer to execute each step of the system according to claim 1.
